(19) United States
(12) Patent Application Publication
(10) Pub. No.: US 2021/0161226 A1
(43) Pub. Date: Jun. 3, 2021

(54) SAFETY GLOVE INCLUDING CHEMICAL RESISTANCE AND IMPACT PROTECTION AND METHOD OF MANUFACTURING THE SAME

(71) Applicant: RINGERS TECHNOLOGIES LLC, Houston, TX (US)

(72) Inventor: Hardy LIM, Houston, TX (US)

(73) Assignee: RINGERS TECHNOLOGIES LLC, Houston, TX (US)

(21) Appl. No.: 16/067,548

(22) PCT Filed: Dec. 28, 2016
(86) PCT No.: PCT/US16/68830

§ 371 Date: Jun. 29, 2018

Related U.S. Application Data
(60) Provisional application No. 62/273,678, filed on Dec. 31, 2015.

(51) Int. Cl. A41D 19/015; A41D 19/00; A62B 17/00

(52) U.S. Cl. CPC A41D 19/01505; A41D 19/0065; A41D 19/0096; A41D 19/01523; A41D 2500/54; A62B 17/006; A41D 2400/80; A41D 2500/10; A41D 19/01558

(57) ABSTRACT

A safety glove includes a knitted inner shell, a first coating covering an exterior surface of the knitted inner shell, a plurality of guard members disposed on the first coating, a second coating covering the first coating and the plurality of guard members, and a third coating covering only a portion of the second coating. A method of manufacturing a safety glove includes kitting fibers to form an inner shell, dipping the inner shell into a first material to form a first coating; securing a plurality of guard members on the first coating, dipping the result into a second material to form a second coating, inspecting the second coating, and, if the second coating passes inspection, dipping only a portion of the result into a third material to form a third coating.

### CROSS-REFERENCE TO RELATED APPLICATIONS

This application claims the benefit of, and priority to, U.S. Provisional Patent Application No. 62/273,678, filed on Dec. 31, 2015, the entire contents of which is hereby incorporated herein by reference.

### BACKGROUND

### Technical Field

The present disclosure relates to safety gloves and, more particularly, to safety gloves including chemical resistance and impact protection, and methods of manufacturing the same.

### Background of Related Art

Safety gloves are commonly used to protect the wearer from hazardous chemicals, fluids, impact trauma, wounds, abrasions, and the like. In addition to providing these protections, safety glove manufacturers strive to provide safety gloves that are comfortable, durable, and do not inhibit the wearer's natural dexterity.

Certain industries require safety gloves having specific levels of protection suitable for use in the environments typical in that particular industry. To this end, standard rating systems have been implemented to enable a user to readily identify whether a particular safety glove is suitable for use in the intended industry. One such system is the European Norm (EN), which designates whether a particular article is compliant with essential requirements. EN 388, for example, designates whether a glove provides adequate protection from mechanical risks. EN 374-1, as another example, designates whether a glove provides chemical resistance (and to what chemicals the glove is sufficiently resistant) and micro-organism resistance. EN 420, as still another example, designates whether a glove meets the general requirements for protective gloves in terms of construction, fitness, safety, etc.

In addition to rating systems such as the EN, markings such as the European Conformity (CE Marking) are utilized by manufacturers to indicate that a particular article complies with the relevant directives for that particular class of articles. With respect to safety gloves, for example, the Personal Protection Equipment (PPE) Directive 89/686/EEC is the relevant directive for achieving CE Marking status.

### SUMMARY

To the extent consistent, any of the aspects and features detailed herein may be used in conjunction with any or all of the other aspects and features detailed herein.

Provided in accordance with aspects of the present disclosure is a safety glove including a knitted inner shell, a first coating covering an exterior surface of the knitted inner shell, a plurality of guard members disposed on the first coating, a second coating covering the first coating and the plurality of guard members, and a third coating covering only a portion of the second coating.

In aspects of the present disclosure, the knitted inner shell is formed from a combination of aramid fibers, cotton fibers, and glass fibers.

In aspects of the present disclosure, the first and/or second coatings are formed from polyvinyl chloride (PVC) materials.

In aspects of the present disclosure, the plurality of guard members is formed from a thermoplastic rubber (TPR) material.

In aspects of the present disclosure, the third coating is formed from a mixture of PVC material and sand.

In aspects of the present disclosure, the plurality of guard members is sewn onto the first coating and the inner shell via nylon threading.

A method of manufacturing a safety glove provided in accordance with aspects of the present disclosure includes kitting fibers to form an inner shell, dipping the result into a first material to form a first coating, securing a plurality of guard members on the result, dipping the result into a second material to form a second coating, inspecting the second coating, and if the second coating passes inspection, dipping only a portion of the result into a third material to form a third coating.

In aspects of the present disclosure, knitting the fibers includes knitting a combination of aramid fibers, cotton fibers, and glass fibers.

In aspects of the present disclosure, the first material is a PVC material, the plurality of guard members is formed from a TPR material, the second material is a PVC material, and/or the third material is a mixture of PVC material and sand.

In aspects of the present disclosure, securing the plurality of guard members on the first coating includes sewing the plurality of guard members onto the first coating and the inner shell using nylon threading.

In aspects of the present disclosure, inspecting the second coating includes determining whether the second coating is uniformly applied.

### BRIEF DESCRIPTION OF THE DRAWINGS

Various aspects and features of the present disclosure are described herein with reference to the drawings wherein like reference numerals identify similar or identical elements and:

FIG. 1 is a perspective view from an upper side of a safety glove provided in accordance with aspects of the present disclosure;

FIG. 2 is a perspective view from a lower side of the safety glove of FIG. 1; and

FIG. 3 is a flow diagram illustrating a method of manufacturing the safety glove of FIG. 1 in accordance with aspects of the present disclosure.

### DETAILED DESCRIPTION

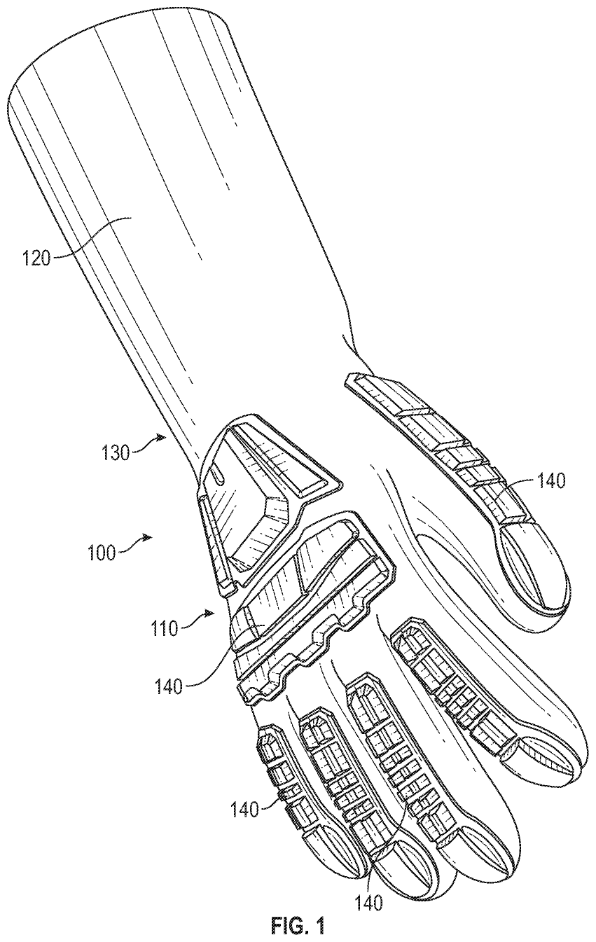

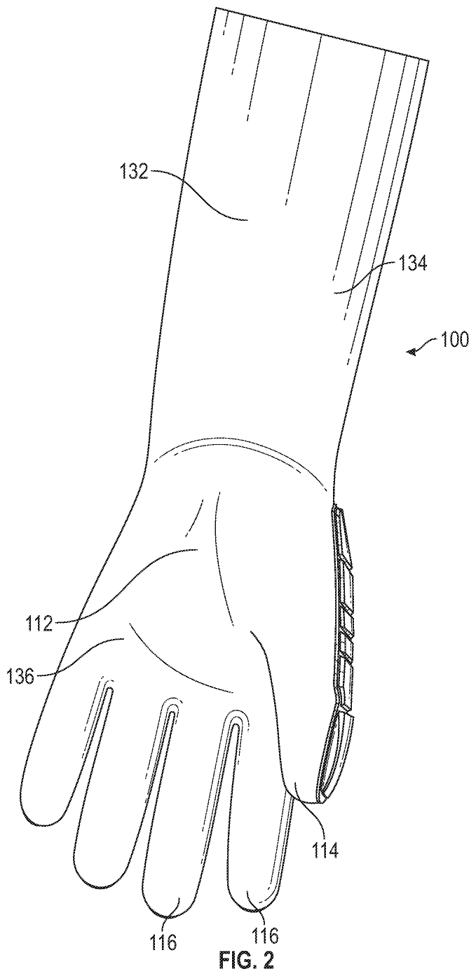

Referring to FIGS. 1 and 2, a safety glove provided in accordance with the present disclosure is shown generally identified by reference numeral 100. Safety glove 100 includes a hand-receiving portion 110 and an elongated wrist portion 120 extending from hand-receiving portion 110. Hand-receiving portion 110 is shaped to generally conform to a human hand and includes a palm 112, a thumb pocket 114, and four (4) finger pockets 116. Elongated wrist portion 120 is integrally formed with hand-receiving portion 110 and defines a length suitable for covering at least a portion of a wearer's lower arm. It is envisioned that various lengths of safety glove 100 may be provided, e.g., small (measuring about 35 cm from the tip end of the middle finger pocket 116 to the open end of elongated wrist portion 120), medium (measuring about 40 cm), and large (measuring about 50 cm), to ensure adequate fitting for a wide range of users.

Safety glove 100 is formed from an inner shell (not shown) that forms the interior surface of safety glove 100 and defines the interior cavity of safety glove 100 so as to contact a wearer's hand and wrist, a plurality of coatings 130 each of which covers at least a portion of safety glove 100, and a plurality of strategically positioned and configured guard members 140. The inner shell (not shown) is knit to form a single construction and is made from a combination of aramid fibers, cotton fibers, and glass fibers. The inner shell (not shown) provides cut resistance, comfort, and sweat absorption. Notably, the inner shell (not shown) extends the entire safety glove 100, e.g., across both hand-receiving portion 110 and elongated wrist 120, so as to provide cut-resistance along the entire safety glove 100. With respect to a percentage, by weight, of safety glove 100: the aramid fibers may comprise, in embodiments from about 2% to about 60%, in other embodiments from about 5% to about 40%, in yet other embodiments from about 15% to about 25%, and still other embodiments from about 17% to about 23%; the cotton fibers may comprise, in embodiments from about 1% to about 60%, in other embodiments from about 3% to about 25%, in yet other embodiments from about 5% to about 15%; and the glass fibers may comprise, in embodiments less than about 30%, in other embodiments from about 1% to about 20%, in yet other embodiments from about 2% to about 8%. As used herein, the term “about ” is intended to represent plus or minus 10% of the numerical value of the number with which it is being used.

The plurality of coatings 130 include at least a first coating 132, a second coating 134, and a third coating, 136. First coating 132 is disposed on and covers the entire exterior surface of the inner shell (not shown). First coating 132 is formed from a waterproof, chemical resistant PVC material, provides strength and structural support to safety glove 100, and serves as a substrate to enable attachment of guard members 140 thereto. First coating 132 is of a bright color, e.g., red, to facilitate visualization of safety glove 100 during use. Second and third coatings 134, 136 are detailed below.

Continuing with reference to FIGS. 1 and 2, guard members 140 of safety glove 100, as noted above, are strategically positioned and configured so as to provide impact protection at the areas most susceptible to impact trauma (fingers, knuckles, and the back of the hand) without compromising a wearer's natural dexterity of the hand and/or fingers. More specifically, a first set of guard members 140 is arranged to extend along the upper side of thumb pocket 114; four (4) second sets of guard members 140 are arranged to extend along the upper sides of finger pockets 116; and a third set of guard members 140 is disposed on the upper side of palm 112. The first and second sets of guard members 140 may be of a bright color, e.g., yellow, different from the color of first coating 132, so as to enable visualization of thumb pocket 114 and finger pockets 116 of safety glove 100 during use and to distinguish thumb pocket 114 and finger pockets 116 from the rest of safety glove 100. Guard members 140 are disposed on first coating 132 are are stitched onto to safety glove 100 using nylon threading. As noted above, first coating 132 provides sufficient structural support to the inner shell so as to serve as a substrate upon which guard members 140 are stitched. Guard members 140 are formed from a thermoplastic rubber (TPR) and may define a thickness, in embodiments, of between about 4 mm and about 8 mm, and, in embodiments, of about 6 mm. Guard members 140 may further define a hardness of about 30 Shore A. The TPR material of guard members 140 may form, by weight, in embodiments from about 5% to about 60%, in other embodiments from about 10% to about 50%, in yet other embodiments from about 25% to about 35% of safety glove 100. Second coating 134 is disposed on and covers first coating 132 and guard members 140. Second coating 134 is formed from a waterproof, chemical resistant PVC material and is transparent so as allow the red color of first coating 132 and the yellow color of guard members 140 to remain visible. Second coating 134 covers the stitching attaching guard members 140 to first coating 132 so as to seal any opening therebetween.

Referring still to FIGS. 1 and 2, third coating 136 is disposed on and covers a portion of second coating 134. More specifically, third coating 136 only covers the portion of second coating 134 disposed about hand-receiving portion 110 of safety glove 100, leaving elongated wrist portion 120 of second coating 134 exposed. Third coating 136 is formed from a waterproof, chemical resistant PVC material and is transparent except that third coating 136 is mixed with granular material such as fine grain sand or other granular material, for example, ground up PVC and/or ground resin. The PVC material and fine granular mixture provides a textured, matte finish on hand-receiving portion 110 of safety glove 100 to enhance gripping and inhibit slippage. The PVC materials, by weight, may comprise, in embodiments from about 5% to about 70%, in other embodiments from about 20% to about 60%, in yet other embodiments from about 35% to about 45% of safety glove 100.

The above-detailed safety glove 100 is CE rated as meeting the requirements of Personal Protection Equipment (PPE) Directive 89/686/EEC. More specifically, safety glove 100 meets the requirements of EN 374-1 for micro-organism resistance; EN 374-1 for chemical resistance with respect to chemicals A (methanol), J (n-Heptan), K (sodium hydroxide 40%), and L (sulfuric acid 96%), as well as general chemical resistance; EN 388; and EN 420. Safety glove 100 is also fluid-proof or fluid-tight and passes the EN 374 air and water leak test. As a PPE, safety glove 100 is also suitably cut-resistant, abrasion-resistant, and tear-resistant.

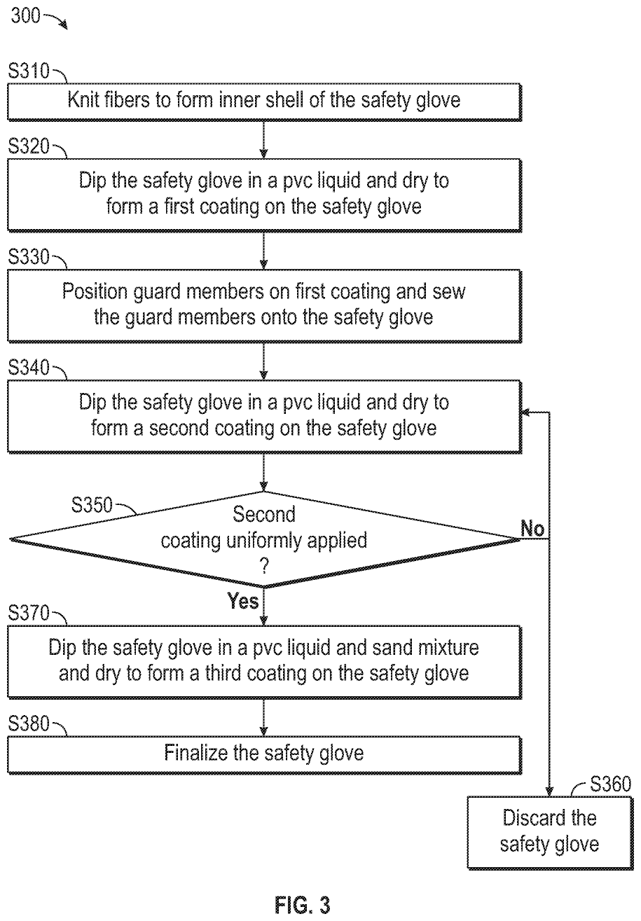

Turning to FIG. 3, a method of manufacturing safety glove 100 in accordance with the present disclosure is detailed. The method of manufacturing 300 initially includes, as indicated at S310, knitting fibers to form the inner shell of the safety glove. As noted above, in embodiments, the inner shell may be formed from a combination of aramid fibers, cotton fibers, and glass fibers. Once the inner shell is formed, the inner shell is dipped in a PVC liquid and allowed to dry to provide the first coating, as indicated at S320. To facilitate drying, the inner shell, with the first coating disposed thereon, is passed through a conveyor-like oven and baked, in some embodiments, for between 4 and 7 minutes or, in some embodiments, between 5 and 6 minutes, and subsequently allowed to cool to room temperature.

Next, the guard members are positioned on the first coating and sewn onto the safety glove, as indicated at S330. As noted above, the guard members may be sewn on using nylon threading. With the guard members sewn on, the method moves to S340, where the safety glove is dipped into a PVC liquid and allowed to dry to provide the second coating. Drying of the second coated may be facilitated similarly as detailed above. Once the second coating has dried, the safety glove is inspected to ensure the second coating has been applied uniformly about the safety glove. At S350, if it is determined that the second coating has been uniformly applied, the method continues to S370. If it is determined at S350 that the second coating has not be uniformly applied, S340 may be repeated to re-apply the second coating or, if the non-uniformity is determined to be too significant, the safety glove is discarded as defective at S360.

At S370, the hand-receiving portion of the safety glove is dipped into a PVC liquid and fine grain sand mixture to provide the third coating, which introduces a textured, matte finish to the safety glove. The third coating is allowed to dry, and such drying may be facilitated similarly as detailed above. Lastly, the glove is finalized at S380, wherein, for example, the open end of the safety glove is trimmed, labels are sewn into the interior of the safety glove, and additional quality control checks are performed.

From the foregoing and with reference to the various drawing figures, those skilled in the art will appreciate that certain modifications can also be made to the present disclosure without departing from the scope of the same. While exemplary embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A safety glove, comprising:
a knitted inner shell;
a first coating covering an exterior surface of the knitted inner shell;
a plurality of guard members disposed on the first coating;
a second coating covering the first coating and the plurality of guard members; and
a third coating covering only a portion of the second coating.

2. The safety glove according to claim 1, wherein the knitted inner shell is formed from a combination of aramid fibers, cotton fibers, and glass fibers.

3. The safety glove according to claim 1, wherein the first coating is formed from a PVC material.

4. The safety glove according to claim 1, wherein the plurality of guard members is formed from a TPR material.

5. The safety glove according to claim 1, wherein the second coating is formed from a PVC material.

6. The safety glove according to claim 1, wherein the third coating is formed from a mixture of PVC material and sand.

7. The safety glove according to claim 1, wherein the plurality of guard members is sewn onto the first coating and the inner shell via nylon threading.

8. A method of manufacturing a safety glove, comprising:
kitting fibers to form an inner shell;
dipping the inner shell into a first material to form a first coating;
securing a plurality of guard members on the first coating;
dipping the inner shell, having the first coating and plurality of guard members disposed thereon, into a second material to form a second coating;
inspecting the second coating; and
if the second coating passes inspection, dipping only a portion of the inner shell, having the first coating, plurality of guard members, and second coating disposed thereon, into a third material to form a third coating.

9. The method according to claim 8, wherein knitting the fibers includes knitting a combination of aramid fibers, cotton fibers, and glass fibers.

10. The method according to claim 8, wherein the first material is a PVC material.

11. The method according to claim 8, wherein the plurality of guard members is formed from a TPR material.

12. The method according to claim 8, wherein the second material is a PVC material.

13. The method according to claim 8, wherein the third material is a mixture of PVC material and sand.

14. The method according to claim 8, wherein securing the plurality of guard members on the first coating includes sewing the plurality of guard members onto the first coating and the inner shell using nylon threading.

15. The method according to claim 8, wherein inspecting the second coating includes determining whether the second coating is uniformly applied.
